(19) United States
(12) Patent Application Publication
(10) Pub. No.: US 2018/0227648 A1
(43) Pub. Date: Aug. 9, 2018

(54) METHOD FOR LIVE BROADCAST BASED ON HLS PROTOCOL AND ELECTRONIC DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Jijian ZHENG, BEIJING (CN)

(73) Assignees: LE HOLDINGS (BEIJING) CO., LTD., Beijing (CN); LE SHI ZHI XIN ELECTRONIC TECHNOLOGY (TIANJIN) LIMITED, Tianjin (CN)

(21) Appl. No.: 15/120,244

(22) PCT Filed: Jun. 7, 2016
(86) PCT No.: PCT/CN2016/085110

§ 371 Date: Aug. 19, 2016

(30) Foreign Application Priority Data
Oct. 29, 2015 (CN) 201510718074.3

(51) Int. Cl. H04N 21/845; H04N 21/8547; H04N 21/858; H04L 29/06

(52) U.S. Cl. CPC H04N 21/8456; H04L 29/06074; H04N 21/858; H04N 21/8547

(57) ABSTRACT

The invention is a method for live broadcast based on HLS protocol and electronic device provided, wherein a M3U8 index list is downloaded from a sub-server and a program resource slice downloaded according to the M3U8 index list is played, after a master server redistributes another sub-server, the M3U8 index list and a program resource slice are downloaded from the new distributed sub-server; the program resource slice downloaded from the new sub-server is analyzed to acquire a PTS timestamp information in the downloaded slice; and the PTS timestamp information in the slice downloaded from the new sub-server is compared with the PTS timestamp information in the slice downloaded from the original sub-server, and it is determined whether the currently downloaded program resource slice is played according to the comparison result. It provides the users with a smooth watching experience of the live broadcast video in one's terminal device.

### CROSS REFERENCE TO RELATED APPLICATIONS

This application is a continuation of International Application No. PCT/CN2016/085110, filed on Jun. 7, 2016, which is based upon and claims priority to Chinese Patent Application No. 2015107180743, filed on Oct. 29, 2015, the entire contents of which are incorporated herein by reference.

### TECHNICAL FIELD

The disclosure relates to network communication technology, in particular to a method for live broadcast based on HLS protocol and electronic device.

### BACKGROUND

Content Delivery Network (CDN) is a new way to build a network, which relies on the edge servers deployed around various regions to allow users to obtain the required content nearby, reduce the network congestion and improve the response speed and hit rate of the user access by load balancing, content distribution, scheduling and other functional modules of the center platform. The basic idea of CDN is to avoid the bottlenecks and links which may affect the speed and stability of data transmission on the Internet as far as possible, so as to achieve a faster and more stable transmission of content. The purpose is to enable users to obtain the required content nearby so as to address the Internet network congestion condition and improve the response speed of the user's access to websites. CDN enables users to more easily request resources from a local server and avoid the whole network congestion by the strategies of load balancing, local caching, etc., which has a very wide range of application in the field of video distribution. The basic principle of CDN is to widely use a variety of CDN cache servers and distribute the cache servers into those regions or networks with relatively dense user access, and when a user accesses the website, the user's access is pointed to the nearest and normal working cache servers by using the global load technology to enable the cache server to response to the user's request in direct. CDN's key technologies include the storage and distribution of content.

HLS (Http live streaming) protocol is an HTTP-based media streaming communications protocol implemented by Apple Inc., in which it works by breaking the continuous stream huge capacity into a sequence of small files for transmission to meet the file transfer between web servers and using a continuous updating and lightweight index file to control the downloads and broadcast of the small divided files, so as to achieve the live broadcast and on-demand broadcast of the media streamings.

By HLS protocol, the processed video data is divided into video program slice TS (Transport Stream) files and media data index M3U8 file (M3U8 file is a M3U file in UTF-8 encode format and M3U file is a pure text file recording index), and they are stored in a cloud server. M3U8 file typically includes a plurality of Uniform Resource Locator (URL) of video clips. After a multimedia player acquires the M3U8 file, the corresponding video clips will be downloaded by the URL and played. The video clips also can be downloaded according to the URLs in the M3U8 file and stored locally for subsequent playback locally.

Currently, the CDN acceleration technology is also widely applied into the live broadcast and on-demand broadcast of video. In mobile phone and television services, it is a most popular way to combine CDN with HLS protocol to implement the live broadcast and on-demand broadcast of video contents.

In the prior art, under the CDN configuration, the live broadcast programs usually use redirection techniques to hide the particular stream URL addresses, which can be implemented by a coordination method of Master URL address of the master server and Sub URL address of each distribution sub-server, for example, the method including that:

1. the client first obtains a Master URL;

2. the client requests the Master URL to the master server;

3. the master server distributes a new Sub URL (denoted URL b) of a sub-server B to the client according to the geographical reality of the client by redirecting technology;

4. the client acquires a live broadcast program M3U8 index list from the server via URL b;

5. the client analyzes the M3U8 index list and downloads specific program streams slices;

6. according to the HLS protocol, the M3U8 index list only contains 3 latest slices in the case of live broadcast and the client has to regularly update the M3U8 index list, so that the client will return to the step 2 to regularly update the M3U8 index list and download new slices, thereby the steps 2-5 will be repeated constantly; and

7. at a certain moment, in the case of the insufficient bandwidth of the sub-server B, CDN can redirect the user's request to a new sub-server H by load balancing to obtain a new URL b.

In the process of implementing the application, the inventor found that there are at least the following issues related to the technology: due to the non-comparability of the M3U8 index files between different sub-servers, the CDN server cannot guarantee the consistency of the distributed stream slices of different sub-servers, so that it is often occurred of the situations of program rebound or program slice missing, etc. in the live broadcast, resulting that the user cannot smoothly watch the live broadcast program, so that the user's experience is reduced.

### SUMMARY

In view of this, an object of the invention is to propose a method for live broadcast based on HLS protocol and electronic device to address the problems of program rebound or program slice missing in the live broadcast

Based on the object, as an embodiment, the present invention provides a method for live broadcast based on HLS protocol, including the steps of:

at an electronic device:

during the live broadcast based on HLS protocol, downloading a M3U8 index list from a sub-server and playing a program resource slice downloaded according to the M3U8 index list, wherein after a master server redistributes another sub-server, downloading the M3U8 index list and a program resource slice from the new distributed sub-server;

analyzing the program resource slice downloaded from the new sub-server and acquiring a PTS timestamp information in the downloaded slice; and

comparing the PTS timestamp information in the slice downloaded from the new sub-server with the PTS timestamp information in the slice downloaded from the original sub-server, and determining whether the currently downloaded program resource slice is played according to the comparison result.

In a further another aspect of an embodiment of the present invention, it is provided an electronic device, including:

at least one processor; and

a memory communicably connected with the at least one processor for storing instructions executable by the at least one processor, wherein execution of the instructions by the at least one processor causes the at least one processor to:

during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;

analyze the program resource slice downloaded from the new sub-server and acquire a PTS timestamp information in the downloaded slice; and

compare the PTS timestamp information in the slice downloaded from the new sub-server with the PTS timestamp information in the slice downloaded from the original sub-server, and determine whether the currently downloaded program resource slice is played according to the comparison result.

In a further another aspect of an embodiment of the present invention, it is provided a non-transitory computer-readable storage medium storing executable instructions that, when executed by an electronic device, cause the electronic device to:

during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;

analyze the program resource slice downloaded from the new sub-server and acquire a PTS timestamp information in the downloaded slice; and

compare the PTS timestamp information in the slice downloaded from the new sub-server with the PTS timestamp information in the slice downloaded from the original sub-server, and determine whether the currently downloaded program resource slice is played according to the comparison result.

As it can be seen that, in the method for live broadcast based on HLS protocol and electronic device provided by the embodiments of the present invention, during the master server redirects a client to another sub-server, the client actively analyzes the program slice obtained from the newly distributed sub-server and acquires the PTS timestamp information therein, and determines whether the program slice has been played repeatedly by comparing it with the PTS timestamp information in the slice downloaded from the original sub-server. Therefore, the invention can address the problems that the CDN server cannot guarantee the consistency of the distributed stream slices of different sub-servers due to the non-comparability of the M3U8 index numbers between different sub-servers, so that it can avoid the occurrences of the situations of program repeat, etc. in the live broadcast and improve the effects of the user's watching the live broadcast program.

It should be understood that both the descriptions in general and in detailed hereinafter are exemplary and explanatory without any limitation to the invention.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram of a method for live broadcast based on HLS protocol in accordance with some embodiments.

FIG. 2 is a schematic flow diagram of a method for live broadcast based on HLS protocol in accordance with some embodiments;

FIG. 3 is a schematic sequential diagram of an method for live broadcast based on HLS protocol in accordance with some embodiments; and

FIG. 4 is a schematic view of a client for live broadcast based on HLS protocol in accordance with some embodiments.

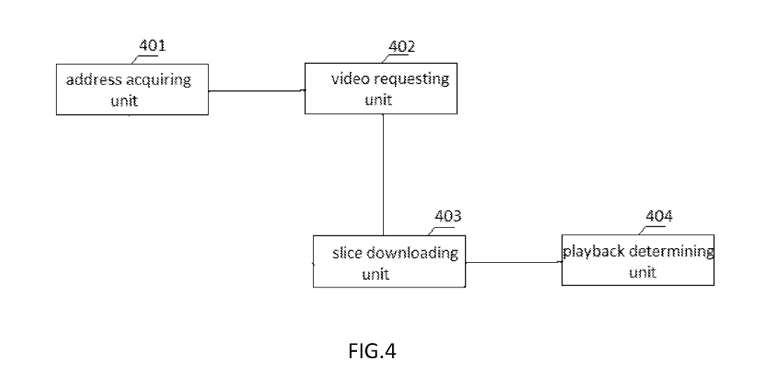

FIG. 5 is a schematic view of an electronic device for live broadcast based on HLS protocol in accordance with some embodiments.

By the above drawings, the embodiments of the present disclosure have been shown clearly and will be described hereinafter in more detail. These drawings and description are not intended in any way to limit the scopes of the disclosure, but describe the concept of the disclosure for the skilled in the art by reference to specific embodiments.

### DETAILED DESCRIPTION

The present invention is described more fully hereinafter with reference to the accompanying drawings so that the objects, technical solutions and advantages of the present invention will become more apparent.

According to the existing HLS protocol, the client downloads the corresponding program slice from the sub-server by the M3U8 index list. However, since the index numbers of the corresponding program slices in the M3U8 index list of the same live broadcast program stored in different sub-servers are different and do not have a comparability, during the master server redirects the client to a new sub-server, it is often caused that the situations of repeat download of the program slice or missing of the slice. To address this problem, in the present invention, it is taken into account that although the index numbers of the same program slice between different sub-servers are different, the PTS timestamp information in the slices having the same content is comparable. Thereby, the idea of the present invention is to add an analysis of the firstly downloaded program slice from the new sub-server during the redirection of sub-server and compare the analyzed PTS timestamp information with the PTS timestamp information in the slice downloaded from the original sub-server, so as to determine whether the program slice has been downloaded repeatedly or the slice is missing.

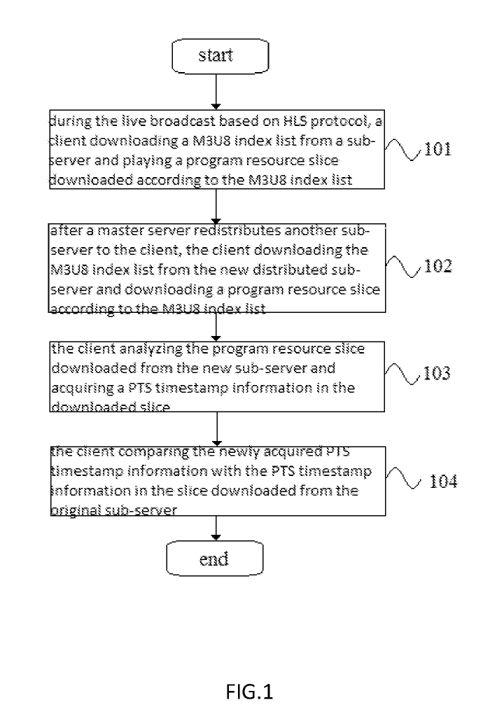

Referring to FIG. 1, it is a schematic flow diagram of a method for live broadcast based on HLS protocol in accordance with some embodiments, wherein the method for live broadcast based on HLS protocol at an electronic device includes the following steps of:

Step 101: during the live broadcast based on HLS protocol, a client downloading a M3U8 index list from a sub-server and playing a program resource slice downloaded according to the M3U8 index list;

Step 102: after a master server redistributes another sub-server to the client, the client downloading the M3U8 index list from the new distributed sub-server and downloading a program resource slice according to the M3U8 index list;

Step 103: the client analyzing the program resource slice downloaded from the new sub-server and acquiring a PTS timestamp information in the downloaded slice; wherein according to HLS protocol, the video data storing in the sub-server includes TS files of video program slices and a M3U8 index list, and the M3U8 index list downloaded each time only includes the index numbers of three video programs, and then the client downloads the corresponding video program slices from the sub-server according to the index number. The video program slice contains the content data of the video program and the PTS timestamp information of the program content. The client can acquires the PTS timestamp information by analyzing the video program slice.

At this time, the client executes Step 104 without directly playing the downloaded video program slice.

Step 104: the client comparing the newly acquired PTS timestamp information with the PTS timestamp information in the slice downloaded from the original sub-server.

Specifically, the client analyzes the PTS timestamp information in the slice newly downloaded and also analyzes the PTS timestamp information in the slice downloaded from the original sub-server, and compares the both.

Step 105: the client determining whether the currently downloaded program resource slice is played according to the comparison result.

There may be several conditions of the comparison result in the step and different processing ways can be employed based on these conditions. As an example, if the newly acquired PTS timestamp information is earlier than or equal to the PTS timestamp information in the local slice, then determining that the newly downloaded slice is already existed in local, and selecting a PTS timestamp information in the next newly downloaded slice to continue to execute the step of comparing it with the PTS timestamp information in the local slice; alternatively, if the newly acquired PTS timestamp information is later than the PTS timestamp information in the local slice, then playing the currently downloaded program resource slice.

Furthermore, for avoiding the occurrence of drop frame or frame skip, after determining that the newly acquired PTS timestamp information is later than the PTS timestamp information in the local slice, the method can also further includes the steps of determining whether the time interval between the newly acquired PTS timestamp information and the PTS timestamp information in the local slice exceeds a preset time threshold; if yes then not playing the currently downloaded program resource slice which can be stored in local first; if no then playing the slice corresponding to the PTS timestamp information.

If the time interval exceeds the preset time threshold, the method can further includes the steps of: the client requesting for downloading the M3U8 index list and program resource slice with a smaller M3U8 index number to the newly distributed sub-server, and repeating the step of the client comparing the newly acquired PTS timestamp information with the PTS timestamp information in the slice downloaded from the original sub-server, until the time interval between the newly acquired PTS timestamp information and the PTS timestamp information in the local slice does not exceed the preset time threshold, and then playing the slice corresponding to the PTS timestamp information.

As a preferred embodiment, in order to improve the effectiveness of PTS timestamp comparison and take into account that the M3U8 index numbers of the slices are generally arranged in an ascending order in turn, the PTS timestamp comparison process in the above-mentioned example can employed the steps of: selecting a slice with the smallest M3U8 index number from the newly downloaded slices and comparing the PTS timestamp information in this slice with the smallest M3U8 index number with the PTS timestamp information in the local slice with the largest M3U8 index number; if the newly acquired PTS timestamp information is earlier than or equal to the PTS timestamp information in the local slice, then selecting the next slice in an ascending order of the M3U8 index numbers in turn from the newly downloaded slices to continue to execute the step of comparing it with the PTS timestamp information in the local slice with the largest M3U8 index number.

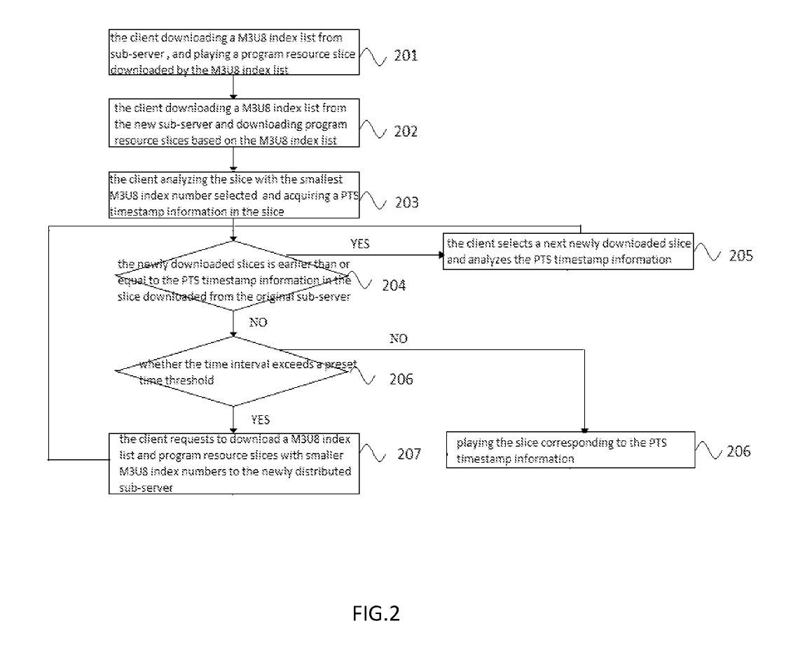

As a referable example, referring to FIG. 2, the method for live broadcast based on HLS protocol can employ the following steps:

Step 201: during the live broadcast based on HLS protocol, the client downloads a M3U8 index list from sub-server B, and plays a program resource slice downloaded by the M3U8 index list.

When the program resource slice cannot be downloaded from the currently downloading sub-server and played due to network error, bandwidth limitation or loss of speed, for example, the updating time of M3U8 index list by the client exceeds a predetermined updating time threshold (such as 10 s) or the downloading time of slice by the client exceeds a predetermined downloading time threshold (such as 20 s), the client will determine an occurrence of network error and report to the master server, and then the master server will redistribute a new sub-server H closer to the client to the client based on the location of the client by the redirecting technology.

Step 202: after the master server redistributes the new sub-server H, the client downloads a M3U8 index list from the sub-server H and downloads program resource slices based on the M3U8 index list.

Step 203: the client analyzes the slice with the smallest M3U8 index number (i.e., the first slice) selected from the program resource slices downloaded from the sub-server H based on the M3U8 index list and acquires PTS timestamp information in the slice.

For example, the three slices downloaded from the sub-server H are 22.ts, 23.ts and 24.ts, the client analyzes the slice 22.ts with the smallest M3U8 index number (i.e., the first slice) and extracts the ES streams of video and audio, to acquire respective PTS timestamp information, e.g., 89.66s.

Step 204: the client compares this PTS timestamp information with the PTS timestamp information analyzed in the slice with the largest M3U8 index number in local (i.e., downloaded from the sub-server B); if it is earlier than or equal to the PTS timestamp information in the local slice, then executing Step 205; otherwise, executing Step 206.

For example, the local slice with the largest M3U8 index number downloaded from the original sub-server (i.e., the last downloaded slice) is 101.ts, which is analyzed to extract the ES streams of video and audio and acquire respective PTS timestamp information, e.g., 110.33s. It is to compare the PTS timestamp information 89.66s of the slice 22.ts with the PTS timestamp information 110.33 of the slice 101.ts, and find the PTS timestamp information 89.66s of the slice 22.ts is earlier than the PTS timestamp information 110.33 of the slice 101.ts, which means the downloaded slice has been played in local, so as to execute Step 205. If the PTS timestamp information of the newly downloaded slice is later than the PTS timestamp information in the local slice, which means the slice has not been played in local, then executing Step 206.

Step 205: the client selects a next newly downloaded slice based on the ascending order of M3U8 index number and analyzes the PTS timestamp information, and returns back to Step 204.

For example, the client analyzes the second slice 23.ts newly downloaded for sub-server B and returns back to Step 204, and then compares the PTS timestamp information in the second slice with the PTS timestamp information in the local slice.

The play backward phenomenon due to repeat playback of the video program slice can be avoided by this step.

Step 206: the client determines whether the time interval between the PTS timestamp information in the second slice and the PTS timestamp information in the local slice exceeds a preset time threshold; if yes then not playing the currently downloaded program resource slice and executing Step 207; if no then playing the slice corresponding to the PTS timestamp information.

The time threshold can be set based on average playback time of each slice, e.g., when the average playback time of each slice is 8s, the time threshold can be set as 8s.

For example, provided that the PTS timestamp information of the newly downloaded slice 22.ts is analyzed as 126.33s, and the preset time threshold is 8s, then the time interval between the PTS timestamp information 126.33s of the newly downloaded slice 22.ts and the PTS timestamp information 110.33s of the local slice 101.ts is 16s which exceeding the preset time threshold 8s, so as to execute Step 207.

Step 207: the client requests to download a M3U8 index list and program resource slices with smaller M3U8 index numbers to the newly distributed sub-server, and returns to Step 204, until the time interval between the newly acquired PTS timestamp information and the PTS timestamp information in the local slice does not exceed the preset time threshold, and then plays the slice corresponding to the PTS timestamp information.

For example, the client downloads a M3U8 index list with smaller index numbers, e.g., the index numbers are 19.ts, 20.ts, 21.ts respectively and the corresponding program resource slices 19.ts, 20.ts, 21.ts are downloaded accordingly. The PTS timestamp information of the first slice is analyzed as 102.33s which is earlier than that in the local slice by compared with the PTS timestamp information 110.33s in the local slice 101.ts, so as to execute Step 205; and then the PTS timestamp information in the next slice 20.ts is analyzed as 110.33 which is equal to that in the local slice by comparison, so as to return back Step 205 again; and then the PTS timestamp information in the third slice 21.ts is analyzed as 118.33s and the time interval between it and PTS timestamp information 110.33s in the local slice 101.ts is 8s without exceeding the preset time threshold 8s, so as to play the third slice.

As can be seen from the above-discussed examples, the method for live broadcast based on HLS protocol of the present invention can effectively avoid the occurrences of play backward and drop frame during the user watching the live broadcasting video, so as to live broadcast fluently.

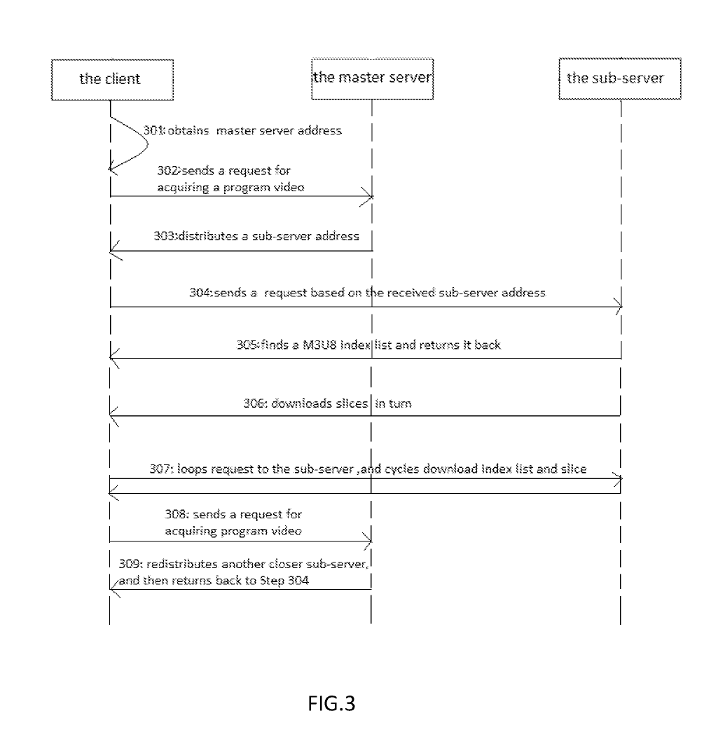

Referring to FIG. 3, an example of the method for live broadcast based on HLS protocol also can includes the following steps:

Step 301: the client obtains a Master URL of a program video master server address based on HLS protocol.

Step 302: the client sends a request for acquiring a program video to the master server based on the Master URL of a program video master server address.

The request for acquiring a program video can includes the IP address of the client, the name of the program video, etc.

Step 303: the master server distributes a sub-server, e.g., sub-server B, based on the IP address of the client, sends the Sub URL B of the sub-server address to the client.

Preferably, the master server distributes a sub-server closest to the client based on the IP address of the client.

Step 304: the client sends a program resource request to the sub-server B based on the received sub-server address and HLS protocol.

Step 305: the sub-server B finds a M3U8 index list of the requested program resource based on the received request and returns it back to the client.

Step 306: the client downloads slices of the program resource in turn from the sub-server B based on the received M3U8 index list.

Step 307: under the situation of normal download of live broadcast program data, the client regularly returns back to Step 304 and continues to acquire the M3U8 index list and the slices of the live broadcast program from the current sub-server B.

Step 308: if the client cannot normally download the live broadcast program from the current sub-server B due to network error, bandwidth limitation or loss of speed, then the client sends a request for acquiring program video to the master server based on the master server address.

Step 309: the master server redistributes another closer sub-server H based on the IP address of the client by the redirecting technology, and sends the address of the sub-server H to the client, and then returns back to Step 304.

According to the HLS protocol, the M3U8 index list only contains 3 latest slices in the case of live broadcast, so that the client has to regularly access the master server to acquire the address of the sub-server distributed by the master server, and then download a new M3U8 index list and the live broadcast program slices from the sub-server. However, in this example, the client does not have to access the master server when every update, but can directly download the new M3U8 index list and the live broadcast program slices from the previously accessed sub-server, and only if it is occurred a communication failure with the current connected sub-server, the client requests for distributing a new sub-server to the master server. In this way, the existing interactive steps are greatly simplified and reduced, so that the user's experience and the fluency of the live broadcast program can be further improved.

In another aspect of the embodiments of the invention, it is provided an system for live broadcast based on HLS protocol, as an example, the system including a client, a master server and a sub-server, wherein the sub-server is used for providing a M3U8 index list and a program resource slice of a live broadcast program; the master server is used for redistributing a sub-server to a client; and the client is used for downloading the M3U8 index list and the program resource slice from a newly distributed sub-server; analyzing the program resource slice downloaded from the new sub-server to acquire a PTS timestamp information; and comparing the PTS timestamp information in the slice downloaded from the new sub-server with the PTS timestamp information in the slice downloaded from the original sub-server, and determining whether the currently downloaded program resource slice is played according to the comparison result.

Preferably, the client is further used for determining that the newly downloaded slice is already existed in local, and selecting a PTS timestamp information in the next newly downloaded slice to continue to execute the step of comparing with the PTS timestamp information in the slice downloaded from the original sub-server. If the PTS timestamp information in the slice downloaded from the new sub-server is later than the PTS timestamp information in the slice downloaded from the original sub-server, then playing the currently downloaded program resource slice.

Preferably, the client is further used for determining whether the time interval between the PTS timestamp information in the slice downloaded from the new sub-server and the PTS timestamp information in the slice downloaded from the original sub-server exceeds a preset time threshold; if yes then not playing the currently downloaded program resource slice which can be stored in local; if no then playing the slice corresponding to the PTS timestamp information.

If the time interval exceeds the preset time threshold, the client is further used for requesting the newly distributed sub-server to download a M3U8 index list and program resource slices with a smaller M3U8 index number, and repeat the step of comparing the PTS timestamp information in the slice downloaded from the new sub-server with the PTS timestamp information in the slice downloaded from the original sub-server until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

As an example, the request for acquiring a program video can includes the IP address of the client, the name of the program video, etc. Preferably, the master server can redistribute a sub-server responding to the request based on the IP address of the client. Preferably, the master server can redistribute a sub-server closest to the client based on the IP address of the client and send the address of the sub-server to the client.

As another example, the client sends a program resource request to the sub-server based on the received sub-server address and HLS protocol. Then, the sub-server finds a slice list of the requested program resource and sends a updated M3U8 index list in HLS protocol to the client to download. Finally, the client determines whether the program resource can be played normally; if it can, then regularly sends a request to the sub-server and updates the M3U8 index list; if it cannot, then acquires another sub-server by the master server again. Preferably, after the client sends a program resource request to the sub-server, it can determine whether the program resource request to the sub-server is success; if yes, then the sub-server finds a slice list of the requested program resource based on the received request; if no, then the client acquires another sub-server by the master server again.

As another embodiments of the present invention, it is provided an client for live broadcast based on HLS protocol, the client as an embodiment including an address acquiring unit 401, a video requesting unit 402, a slice downloading unit 403 and a playback determining unit 404 which are communicated in sequence.

The address acquiring unit 401 can acquire an address of a master server of program video and send a request for acquiring the program video to the master server based on the address of the master server. The video requesting unit 402 can sending a program resource request to the sub-server based on an address of a sub-server distributed by the master server and HLS protocol. Preferably, the video requesting unit 402 can determine whether the program resource request to the sub-server is success; if yes, then the sub-server finds a slice list of the requested program resource based on the received request; if no, then the client acquires another sub-server by the master server again.

The slice downloading unit 403 can download a updated M3U8 index list in HLS protocol from the sub-server. The playback determining unit 404 can determine whether the video slices downloaded based on the M3U8 index list can be played normally; if it can, then the playback determining unit 404 is communicated with the video requesting unit 402 to circularly update the M3U8 index list in HLS protocol until complete the download of whole video program; if it cannot, then the playback determining unit 404 is communicated with the address acquiring unit 401 to acquire different sub-server addresses to acquire the program videos by the master server again.

Furthermore, when the slice downloading unit 403 analyzes and downloads the program resource slices based on the M3U8 index list sent by the newly distributed sub-server, the playback determining unit 404 has to acquire the PTS timestamp information in the slice in the M3U8 index list and compare the newly acquired PTS timestamp information with the PTS timestamp information in the local downloaded program resource slice, and determine whether the currently downloaded program resource slice is played according to the comparison result.

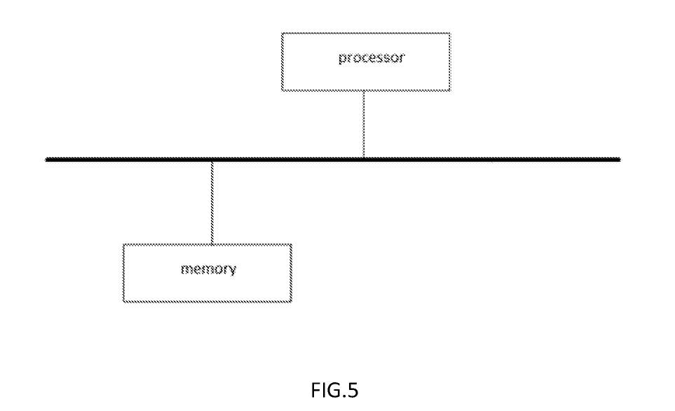

Referring to FIG. 5, in a further another aspect of an embodiment of the present invention, it is provided an electronic device, as an example, the electronic device including:

at least one processor; and

a memory communicably connected with the at least one processor for storing instructions executable by the at least one processor, wherein execution of the instructions by the at least one processor causes the at least one processor to:

during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;

analyze the program resource slice downloaded from the new sub-server and acquire a PTS timestamp information in the downloaded slice; and

compare the PTS timestamp information in the slice downloaded from the new sub-server with the PTS timestamp information in the slice downloaded from the original sub-server, and determine whether the currently downloaded program resource slice is played according to the comparison result.

Preferably, the processor is further used for executing the step of determining whether the currently downloaded program resource slice is played according to the comparison result, which includes the steps of:

if the PTS timestamp information in the slice downloaded from the new sub-server is earlier than or equal to the PTS timestamp information in the slice downloaded from the original sub-server, then determining that the newly downloaded slice is already existed in local, and selecting a PTS timestamp information in the next newly downloaded slice to continue to execute the step of comparing with the PTS timestamp information in the slice downloaded from the original sub-server; and/or

if the PTS timestamp information in the slice downloaded from the new sub-server is later than the PTS timestamp information in the slice downloaded from the original sub-server, then playing the currently downloaded program resource slice.

Preferably, the processor is further used for executing the step of comparing the PTS timestamp information in the slice downloaded from the new sub-server with the PTS timestamp information in the slice downloaded from the original sub-server, which includes the steps of:

selecting a slice with the smallest M3U8 index number from the newly downloaded slices and comparing the PTS timestamp information in this slice with the smallest M3U8 index number with the PTS timestamp information in the slice with the largest M3U8 index number downloaded from the original sub-server; and

if the PTS timestamp information in the slice selected from the newly downloaded slices is earlier than or equal to the PTS timestamp information in the slice downloaded from the original sub-server, then selecting the next slice in an ascending order of the M3U8 index number in turn from the newly downloaded slices to continue to execute the step of comparing the PTS timestamp information in this slice with the PTS timestamp information in the slice with the largest M3U8 index number downloaded from the original sub-server.

Preferably, after determining that the PTS timestamp information in the slice downloaded from the new sub-server is later than the PTS timestamp information in the slice downloaded from the original sub-server, the processor is further used for executing the step of:

determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

Preferably, after it is determined that the time interval between the PTS timestamp information in the slice downloaded from the new sub-server and the PTS timestamp information in the slice downloaded from the original sub-server exceeds a preset time threshold, the processor is further used for executing the step of:

requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

Preferably, the processor is further used for executing that after each time of downloading the program resource slice from the sub-server, if the download process is normal, then directly downloading the M3U8 index list and program resource slice from the current sub-server at next time; otherwise, requesting for redistributing a new sub-server to the master server.

In a further another aspect of an embodiment of the present invention, it is provided a non-transitory computer readable storage medium storing executable instructions that, when executed by an electronic device with a touch-sensitive display, cause the electronic device to:

during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;

analyze the program resource slice downloaded from the new sub-server and acquire a PTS timestamp information in the downloaded slice; and

compare the PTS timestamp information in the slice downloaded from the new sub-server with the PTS timestamp information in the slice downloaded from the original sub-server, and determine whether the currently downloaded program resource slice is played according to the comparison result.

In some embodiments of the present invention, the non-transitory computer-readable storage medium wherein determining whether the currently downloaded program resource slice is played according to the comparison result, further including:

if the PTS timestamp information in the slice downloaded from the new sub-server is earlier than or equal to the PTS timestamp information in the slice downloaded from the original sub-server, then determining that the newly downloaded slice is already existed in local, and selecting a PTS timestamp information in the next newly downloaded slice to continue to execute the step of comparing with the PTS timestamp information in the slice downloaded from the original sub-server; and/or

if the PTS timestamp information in the slice downloaded from the new sub-server is later than the PTS timestamp information in the slice downloaded from the original sub-server, then playing the currently downloaded program resource slice.

In some embodiments of the present invention, the non-transitory computer-readable storage medium wherein after determining that the PTS timestamp information in the slice downloaded from the new sub-server is later than the PTS timestamp information in the slice downloaded from the original sub-server, further used for executing the step of:

determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

In some embodiments of the present invention, the non-transitory computer-readable storage medium wherein after it is determined that the time interval between the PTS timestamp information in the slice downloaded from the new sub-server and the PTS timestamp information in the slice downloaded from the original sub-server exceeds a preset time threshold, further used for executing the step of:

requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

In some embodiments of the present invention, the non-transitory computer-readable storage medium wherein the step of comparing the PTS timestamp information in the slice downloaded from the new sub-server with the PTS timestamp information in the slice downloaded from the original sub-server, which includes the steps of:

selecting a slice with the smallest M3U8 index number from the newly downloaded slices and comparing the PTS timestamp information in this slice with the smallest M3U8 index number with the PTS timestamp information in the slice with the largest M3U8 index number downloaded from the original sub-server; and

if the PTS timestamp information in the slice selected from the newly downloaded slices is earlier than or equal to the PTS timestamp information in the slice downloaded from the original sub-server, then selecting the next slice in an ascending order of the M3U8 index number in turn from the newly downloaded slices to continue to execute the step of comparing the PTS timestamp information in this slice with the PTS timestamp information in the slice with the largest M3U8 index number downloaded from the original sub-server.

In some embodiments of the present invention, the non-transitory computer-readable storage medium wherein after determining that the PTS timestamp information in the slice downloaded from the new sub-server is later than the PTS timestamp information in the slice downloaded from the original sub-server, further used for executing the step of:

determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

In a word, the method for live broadcast based on HLS protocol and electronic device provided by the embodiments of the present invention creatively addressed the problems of drop frame, frame skip and repeat playback and saved the time consumption of network interaction, so that the live broadcast program is more fluent and the live experience is improved. The method for live broadcast based on HLS protocol and electronic device are simple, compact and easy to implement.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As a example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct Ram bus RAM (DRRAM). The disclosed aspects of the storage devices are intended to include, but not limited to these and other suitable types of memory.

Those skilled in the art will also understand that a combination of the illustrative logical blocks, modules, circuits, and algorithm steps described in this disclosure may be implemented as electronic hardware, computer software, or both. To clearly illustrate the interchangeability between hardware and software, various illustrative components, blocks, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical blocks, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present invention, and there are many other variations of the different aspects of the present invention as described herein without description in the details for simplicity. Thus, any omissions, modifications, equivalent replacements and improvements made in the spirit and principles of the present invention should be included within the scopes of the present invention.

To be claimed:

1. A method for live broadcast based on HLS protocol, comprising:
at an electronic device:
during the live broadcast based on HLS protocol, downloading a M3U8 index list from a sub-server and playing a program resource slice downloaded according to the M3U8 index list, wherein after a master server redistributes another sub-server, downloading the M3U8 index list and a program resource slice from the new distributed sub-server;
analyzing the program resource slice downloaded from the new sub-server and acquiring a PTS timestamp information in the downloaded slice; and
comparing the PTS timestamp information in the slice downloaded from the new sub-server with the PTS timestamp information in the slice downloaded from the original sub-server, and determining whether the currently downloaded program resource slice is played according to the comparison result.

2. The method according to claim 1, wherein the step of determining whether the currently downloaded program resource slice is played according to the comparison result comprises the steps of:
if the PTS timestamp information in the slice downloaded from the new sub-server is earlier than or equal to the PTS timestamp information in the slice downloaded from the original sub-server, then determining that the newly downloaded slice is already existed in local, and selecting a PTS timestamp information in the next newly downloaded slice to continue to execute the step of comparing with the PTS timestamp information in the slice downloaded from the original sub-server; and/or
if the PTS timestamp information in the slice downloaded from the new sub-server is later than the PTS timestamp information in the slice downloaded from the original sub-server, then playing the currently downloaded program resource slice.

3. The method according to claim 2, wherein after determining that the PTS timestamp information in the slice downloaded from the new sub-server is later than the PTS timestamp information in the slice downloaded from the original sub-server, the method further comprises the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

4. The method according to claim 3, wherein after it is determined that the time interval between the PTS timestamp information in the slice downloaded from the new sub-server and the PTS timestamp information in the slice downloaded from the original sub-server exceeds a preset time threshold, the method further comprises the step of:
requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server, until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

5. The method according to claim 2, wherein the step of comparing the PTS timestamp information in the slice downloaded from the new sub-server with the PTS timestamp information in the slice downloaded from the original sub-server comprises the steps of:
selecting a slice with the smallest M3U8 index number from the newly downloaded slices and comparing the PTS timestamp information in this slice with the smallest M3U8 index number with the PTS timestamp information in the slice with the largest M3U8 index number downloaded from the original sub-server; and
if the PTS timestamp information in the slice selected from the newly downloaded slices is earlier than or equal to the PTS timestamp information in the slice downloaded from the original sub-server, then selecting the next slice in an ascending order of the M3U8 index number in turn from the newly downloaded slices to continue to execute the step of comparing the PTS timestamp information in this slice with the PTS timestamp information in the slice with the largest M3U8 index number downloaded from the original sub-server.

6. The method according to claim 5, wherein after determining that the PTS timestamp information in the slice downloaded from the new sub-server is later than the PTS timestamp information in the slice downloaded from the original sub-server, the method further comprises the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

7. The method according to claim 6, wherein after it is determined that the time interval between the PTS timestamp information in the slice downloaded from the new sub-server and the PTS timestamp information in the slice downloaded from the original sub-server exceeds a preset time threshold, the method further comprises the step of:
requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server, until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

8. The method according to claim 1, wherein after each time of downloading the program resource slice from the sub-server, if the download process is normal, then directly downloading the M3U8 index list and program resource slice from the current sub-server at next time; otherwise, requesting for redistributing a new sub-server to the master server.

9. An electronic device, comprising: at least one processor; and
a memory communicably connected with the at least one processor for storing instructions executable by the at least one processor, wherein execution of the instructions by the at least one processor causes the at least one processor to:—during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;
analyze the program resource slice downloaded from the new sub-server and acquire a PTS timestamp information in the downloaded slice; and
compare the PTS timestamp information in the slice downloaded from the new sub-server with the PTS timestamp information in the slice downloaded from the original sub-server, and determine whether the currently downloaded program resource slice is played according to the comparison result.

10. The electronic device according to claim 9, wherein the processor is further used for executing the step of determining whether the currently downloaded program resource slice is played according to the comparison result, which comprises the steps of:
if the PTS timestamp information in the slice downloaded from the new sub-server is earlier than or equal to the PTS timestamp information in the slice downloaded from the original sub-server, then determining that the newly downloaded slice is already existed in local, and selecting a PTS timestamp information in the next newly downloaded slice to continue to execute the step of comparing with the PTS timestamp information in the slice downloaded from the original sub-server; and/or
if the PTS timestamp information in the slice downloaded from the new sub-server is later than the PTS timestamp information in the slice downloaded from the original sub-server, then playing the currently downloaded program resource slice.

11. The electronic device according to claim 10, wherein after determining that the PTS timestamp information in the slice downloaded from the new sub-server is later than the PTS timestamp information in the slice downloaded from the original sub-server, the processor is further used for executing the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

12. The electronic device according to claim 11, wherein after it is determined that the time interval between the PTS timestamp information in the slice downloaded from the new sub-server and the PTS timestamp information in the slice downloaded from the original sub-server exceeds a preset time threshold, the processor is used for executing the step of:
requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

13. The electronic device according to claim 10, wherein the processor is further used for executing the step of comparing the PTS timestamp information in the slice downloaded from the new sub-server with the PTS timestamp information in the slice downloaded from the original sub-server, which comprises the steps of:
selecting a slice with the smallest M3U8 index number from the newly downloaded slices and comparing the PTS timestamp information in this slice with the smallest M3U8 index number with the PTS timestamp information in the slice with the largest M3U8 index number downloaded from the original sub-server; and
if the PTS timestamp information in the slice selected from the newly downloaded slices is earlier than or equal to the PTS timestamp information in the slice downloaded from the original sub-server, then selecting the next slice in an ascending order of the M3U8 index number in turn from the newly downloaded slices to continue to execute the step of comparing the PTS timestamp information in this slice with the PTS timestamp information in the slice with the largest M3U8 index number downloaded from the original sub-server.

14. The electronic device according to claim 13, wherein after determining that the PTS timestamp information in the slice downloaded from the new sub-server is later than the PTS timestamp information in the slice downloaded from the original sub-server, the processor is further used for executing the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

15. A non-transitory computer-readable storage medium storing executable instructions that, when executed by an electronic device, cause the electronic device to:
during the live broadcast based on HLS protocol, download a M3U8 index list from a sub-server and play a program resource slice downloaded according to the M3U8 index list, wherein after a master server redistributes another sub-server, download the M3U8 index list and a program resource slice from the new distributed sub-server;
analyze the program resource slice downloaded from the new sub-server and acquire a PTS timestamp information in the downloaded slice; and
compare the PTS timestamp information in the slice downloaded from the new sub-server with the PTS timestamp information in the slice downloaded from the original sub-server, and determine whether the currently downloaded program resource slice is played according to the comparison result.

16. The non-transitory computer-readable storage medium to claim 15, wherein determining whether the currently downloaded program resource slice is played according to the comparison result, which comprises the steps of:
if the PTS timestamp information in the slice downloaded from the new sub-server is earlier than or equal to the PTS timestamp information in the slice downloaded from the original sub-server, then determining that the newly downloaded slice is already existed in local, and selecting a PTS timestamp information in the next newly downloaded slice to continue to execute the step of comparing with the PTS timestamp information in the slice downloaded from the original sub-server; and/or
if the PTS timestamp information in the slice downloaded from the new sub-server is later than the PTS timestamp information in the slice downloaded from the original sub-server, then playing the currently downloaded program resource slice.

17. The non-transitory computer-readable storage medium to claim 16, wherein after determining that the PTS timestamp information in the slice downloaded from the new sub-server is later than the PTS timestamp information in the slice downloaded from the original sub-server, further used for executing the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.

18. The non-transitory computer-readable storage medium to claim 17, wherein after it is determined that the time interval between the PTS timestamp information in the slice downloaded from the new sub-server and the PTS timestamp information in the slice downloaded from the original sub-server exceeds a preset time threshold, further used for executing the step of:
requesting to download a M3U8 index list and a program resource slice with a smaller M3U8 index number to the newly distributed sub-server, and repeat the step of comparing the PTS timestamp information in the slice downloaded from the new sub-server with the PTS timestamp information in the slice downloaded from the original sub-server until the time interval between the PTS timestamp information in the slice downloaded from the new sub-server and the PTS timestamp information in the slice downloaded from the original sub-server does not exceed the preset time threshold, and then playing the slice corresponding to the PTS timestamp information.

19. The non-transitory computer-readable storage medium to claim 16, wherein the step of comparing the PTS timestamp information in the slice downloaded from the new sub-server with the PTS timestamp information in the slice downloaded from the original sub-server, which comprises the steps of:
selecting a slice with the smallest M3U8 index number from the newly downloaded slices and comparing the PTS timestamp information in this slice with the smallest M3U8 index number with the PTS timestamp information in the slice with the largest M3U8 index number downloaded from the original sub-server; and
if the PTS timestamp information in the slice selected from the newly downloaded slices is earlier than or equal to the PTS timestamp information in the slice downloaded from the original sub-server, then selecting the next slice in an ascending order of the M3U8 index number in turn from the newly downloaded slices to continue to execute the step of comparing the PTS timestamp information in this slice with the PTS timestamp information in the slice with the largest M3U8 index number downloaded from the original sub-server.

20. The non-transitory computer-readable storage medium to claim 19, wherein after determining that the PTS timestamp information in the slice downloaded from the new sub-server is later than the PTS timestamp information in the slice downloaded from the original sub-server, further used for executing the step of:
determining whether the time interval between the PTS timestamp information in the slice downloaded from the new sub-server and the PTS timestamp information in the slice downloaded from the original sub-server exceeds a preset time threshold; if yes then not playing the currently downloaded program resource slice; if no then playing the slice corresponding to the PTS timestamp information.
